(19) United States
(12) Patent Application Publication
(10) Pub. No.: US 2021/0002150 A1
(43) Pub. Date: Jan. 7, 2021

(54) WATER TREATMENT SYSTEM

(71) Applicant: KABUSHIKI KAISHA TOSHIBA, Tokyo (JP)

(72) Inventors: Naohiko SHIMURA, Atsugi (JP); Seiichi MURAYAMA, Fuchu (JP); Kanako NAKAJIMA, Yokohama (JP); Ryutaro MAKISE, Yokohama (JP); Kie KUBO, Kawasaki-shi (JP)

(73) Assignee: KABUSHIKI KAISHA TOSHIBA, Minato-ku (JP)

(21) Appl. No.: 16/761,412

(22) PCT Filed: Oct. 4, 2018
(86) PCT No.: PCT/JP2018/037276

§ 371 Date: May 4, 2020

(30) Foreign Application Priority Data
Nov. 10, 2017 (JP) 2017-217447

(51) Int. Cl. C02F 1/467; C02F 1/461; B01F 3/04; B01F 5/04

(52) U.S. Cl. CPC C02F 1/4672; C02F 1/46109; B01F 3/0446; B01F 5/0413; C02F 2001/46161; C02F 2001/46138; C02F 2305/023; C02F 2201/4617; C02F 2201/782; C02F 2201/784; B01F 2215/0052

(57) ABSTRACT

A water treatment system includes: a water treatment device; a feed-water pump that feeds water to be treated to the water treatment device; an ozone generator that generates ozone-containing gas containing ozone gas and oxygen gas; and a direct-current power supply that supplies direct-current power. The water treatment device includes: an ejector including an inlet-side wider-diameter part into which the water is introduced, a nozzle in communication with the inlet-side wider-diameter part and including a sidewall including an inlet opening into which the ozone-containing gas is introduced, and an outlet-side wider-diameter part in communication with the nozzle, from which the water mixed with the ozone-containing gas is ejected; and an electrolyzer located downstream of the ejector and including an electrolysis-purpose electrode supplied with the direct-current power to electrolyze the ejected water mixed with the ozone-containing gas.

### FIELD

Embodiments according to the present invention relate generally to a water treatment system.

### BACKGROUND

Conventionally, ozone has been used for water treatment such as oxidative decomposition, sterilization, and deodorization of organic substances in the fields of water supply, sewage, industrial wastewater, and swimming pools. Through ozone oxidization, however, organic substances can be made hydrophilic or low-molecular but cannot be turned into inorganic substances. Further, persistent organic substances including dioxin and 1,4-dioxane are non-decomposable.

In view of this, to decompose such persistent organic substances in water, an advanced oxidation treatment method using hydroxyl (OH) radicals with higher oxidizing power than ozone is proposed. As for the advanced oxidation treatment method, adding ozone to water containing hydrogen peroxide is known as one of OH-radical generation methods.

### CITATION LIST

### Patent Literature

Patent Literature 1: Japanese Translation of PCT International Application No. 2002-531704

Patent Literature 2: Japanese Laid-open Patent Application Publication No. 2010-137151

Patent Literature 3: Japanese Laid-open Patent

### SUMMARY OF THE INVENTION

### Problem to be Solved by the Invention

The use of ozone and hydrogen peroxide may require preparation of a storage facility and an injection facility for hydrogen peroxide being a deleterious substance, which involves stricter safety control.

In view of the above, it is an object of the present invention is to provide a water treatment system that can generate OH radicals having higher oxidizing power to oxidatively decompose persistent substances in water without use of hydrogen peroxide as a reagent.

### Means for Solving Problem

According to one embodiment, a water treatment system includes a water treatment device; a feed-water pump that feeds water to be treated to the water treatment device; an ozone generator that generates ozone-containing gas containing ozone gas and oxygen gas; and a direct-current power supply that supplies direct-current power. The water treatment device includes an ejector including an inlet-side wider-diameter part into which the water is introduced, a nozzle in communication with the inlet-side wider-diameter part and having a sidewall provided with an inlet opening into which the ozone-containing gas is introduced, and an outlet-side wider-diameter part in communication with the nozzle, from which the water mixed with the ozone-containing gas is ejected; and an electrolyzer located downstream of the ejector and including an electrolysis-purpose electrode supplied with the direct-current power to electrolyze the ejected water mixed with the ozone-containing gas.

### BRIEF DESCRIPTION OF DRAWINGS

FIG. 1 is a schematic configuration block diagram of a water treatment system according to a first embodiment;

FIG. 2 is a perspective view of the outer appearance of a water treatment unit;

FIG. 3 is a sectional schematic view of the water treatment unit;

FIG. 4 illustrates an exemplary configuration of an electrolysis-purpose electrode cluster;

FIG. 5 illustrates an exemplary configuration of an electrolysis-purpose electrode cluster including pairs of electrodes;

FIG. 6 is a schematic configuration block diagram of a water treatment system according to a second embodiment;

FIG. 7 is a schematic configuration block diagram of a water treatment system according to a third embodiment;

FIG. 8 illustrates electrodes according to a first modification of the embodiments;

FIG. 9 illustrates an electrode according to a second modification of the embodiments; and

FIG. 10 illustrates electrodes according to a third modification of the embodiments.

### DETAILED DESCRIPTION

The following will describe embodiments with reference to the accompanying drawings.

### 1. First Embodiment

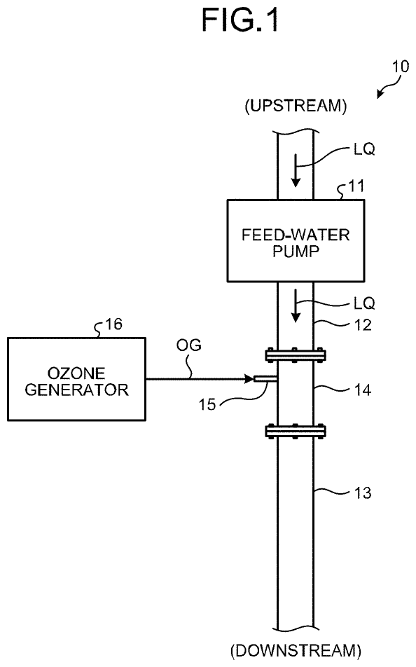

FIG. 1 is a schematic configuration block diagram of a water treatment system according to a first embodiment.

A water treatment system 10 includes a feed-water pump 11, an upstream existing pipe 12, a downstream existing pipe 13, a water treatment unit 14, and an ozone generator 16. The feed-water pump 11 feeds water LQ to be treated while pressurizing the water LQ. The water treatment unit 14 is installed between the upstream existing pipe 12 and the downstream existing pipe 13. The ozone generator 16 supplies ozone (O₃) through an ozone supply pipe 15 of the water treatment unit 14.

The ozone generator 16 electrically discharges in oxygen serving as a raw gas or in dry air, to generate ozone gas, and supply ozone-containing gas (=O₃+O₂ or O₃ +O₂+N₂) containing the ozone gas.

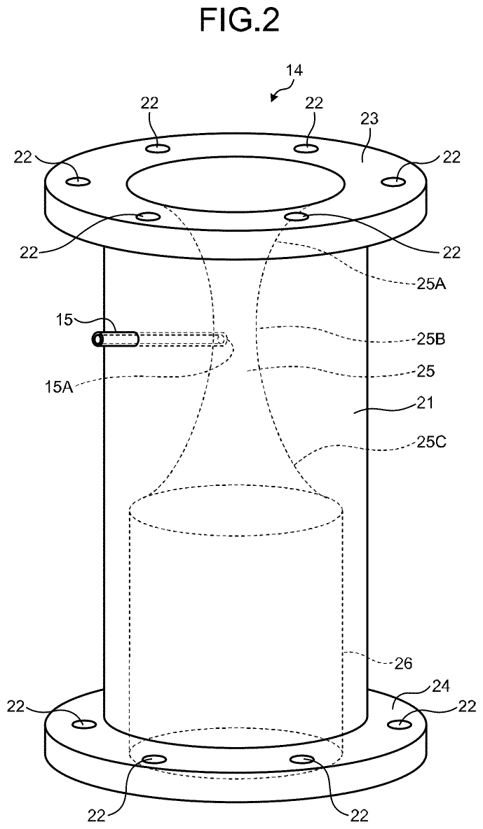

FIG. 2 is a perspective view of the outer appearance of the water treatment unit.

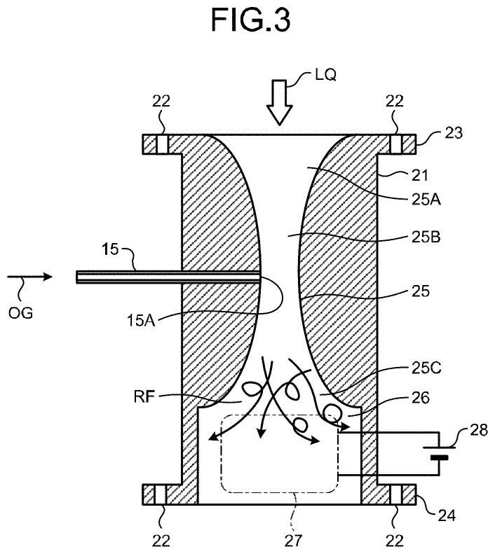

FIG. 3 is a sectional schematic view of the water treatment unit.

The water treatment unit 14 includes a body 21, a pair of flanges 23 and 24 with respective holes 22 for bolt fastening, and the ozone supply pipe 15 located in the body 21 closer to the flange 23.

The body 21 contains an ejector 25 near the flange 23 (upper side in FIG. 2) and an electrolyzer 26. The ejector 25 has a flow channel of a gradually decreasing and increasing diameter, and at the narrowest part of the flow channel the body 21 is provided with an ozone supply opening 15A for the ozone supply pipe 15. The electrolyzer 26 includes later-described electrodes (or an electrode cluster) and serves to generate hydrogen peroxide (H₂O₂).

The ejector 25 includes an inlet-side wider-diameter part 25A, a nozzle 25B, and an outlet-side wider-diameter part 25C.

The principle of treatment by the water treatment unit 14 is now described.

The water LQ is pressurized by the feed-water pump 11 and fed to the ejector 25 of the water treatment unit 14. While flowing through the flow channel of the ejector 25 gradually decreasing in diameter from the inlet-side wider-diameter part 25A to the nozzle 25B, the water LQ gradually increases in speed (flow rate).

At the nozzle 25B being the narrowest part of the flow channel of the ejector 25, that is, the location of the ozone supply opening 15A of the ozone supply pipe 15, the water LQ flows at a highest flow rate and is depressurized due to the Venturi effect.

Consequently, ozone-containing gas OG is supplied from the ozone generator 16 and suctioned into the nozzle 25B of the ejector 25.

At the outlet-side wider-diameter part 25C of the ejector 25 gradually increasing in channel diameter, the water LQ rapidly decreases in flow rate and rises in water pressure at the same time and turbulence occurs, which causes the water LQ and the ozone-containing gas OG to be vigorously mixed with each other.

The water LQ and the ozone-containing gas are then substantially uniformly mixed and flows to the electrolyzer 26 where the electrodes of the electrolyzer 26 generate hydrogen peroxide (H₂O₂) from the ozone-containing gas OG using oxygen gas contained therein as a raw material, by the following Formula (1):

O₂+2H⁺+2e⁻→H₂O₂. (1)

Generated hydrogen peroxide reacts with dissolved ozone in the water LQ to generate OH radicals having higher oxidizing power.

The generated OH radicals react with aquatic compound components (components to be treated) contained in the water LQ, which advances decomposition of persistent compound components in the water.

Along with the decomposition of persistent compound components in the water, hydrogen peroxide and dissolved ozone are both consumed.

However, the ozone-containing gas OG is continuously supplied, so that the water LQ continuously contains newly dissolved ozone O₃, whereby hydrogen peroxide is continuously generated.

Thus, the water treatment unit 14 can maintain a dissolved ozone concentration and a hydrogen peroxide concentration sufficient for water treatment, to continue to perform the advanced oxidation treatment of the water LQ.

As described above, at the outlet-side wider-diameter part 25C of the ejector 25 gradually increasing in channel diameter, the water LQ rapidly decreases in flow rate and rises in water pressure at the same time.

As a result, turbulence RF occurs, as illustrated in FIG. 3, causing the water LQ and the ozone-containing gas OG to be vigorously mixed up.

It is, however, desirable that hydrogen peroxide be uniformly distributed in the electrolyzer 26.

Thus, it is preferable for the electrolysis-purpose electrodes of the electrolyzer 26 not to hinder the generated turbulence as much as possible.

The following will describe in detail the electrolysis-purpose electrodes of the electrolyzer 26 configured not to hinder the generated turbulence as much as possible.

As illustrated in FIG. 3, the electrolyzer 26 includes an electrolysis-purpose electrode cluster 27 located immediately downstream of the outlet-side wider-diameter part 25C of the ejector 25. The electrolysis-purpose electrode cluster 27 is supplied with direct current for electrolysis from an external direct-current power supply 28.

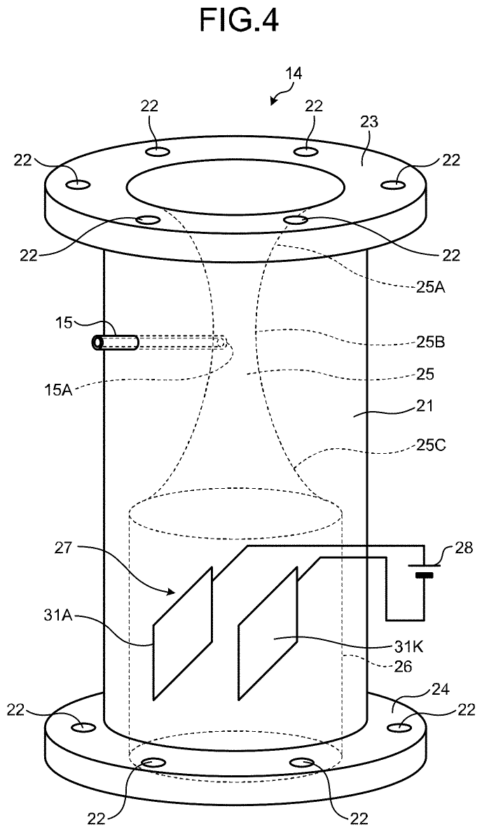

FIG. 4 illustrates an exemplary configuration of an electrolysis-purpose electrode cluster.

The electrolysis-purpose electrode cluster 27 in the electrolyzer 26 includes an anode electrode 31A of a plate form and a cathode electrode 31K of a plate form.

As illustrated in FIG. 4, the anode electrode 31A and the cathode electrode 31K are sufficiently spaced apart from each other so as not to interfere the turbulence RF occurring at the outlet-side wider-diameter part 25C.

Although the anode electrode 31A and the cathode electrode 31K do not hinder the turbulence RF, not both of the anode electrode 31A and the cathode electrode 31K but the anode electrode 31A alone generates hydrogen peroxide (H₂O₂) from the ozone-containing gas OG, using oxygen gas as a raw material. This may not lead to sufficiently improving the reaction rate, and improving hydrogen-peroxide generation efficiency and OH-radical generation efficiency.

In view of this, it is desirable to arrange the electrodes in a manner to improve the reaction rate.

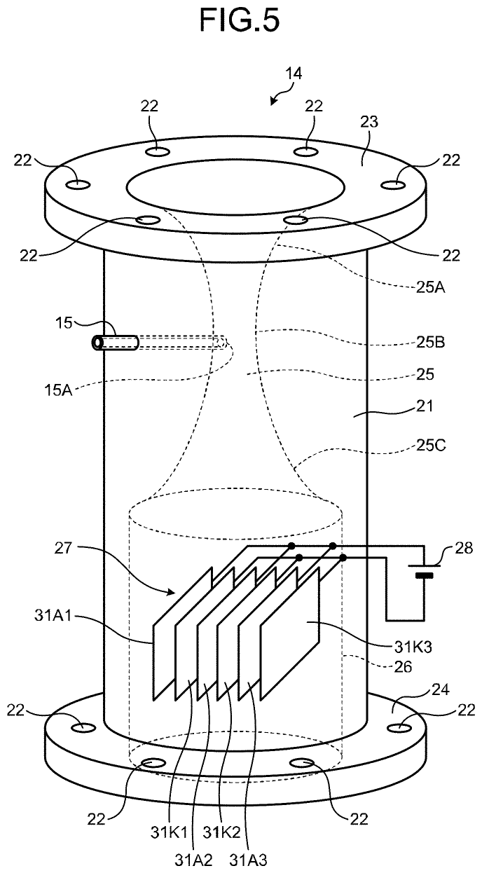

FIG. 5 illustrates an exemplary configuration of the electrolysis-purpose electrode cluster including pairs of electrodes.

In the first embodiment, as illustrated in FIG. 5, anode electrodes 31A1 to 31A3 and cathode electrodes 31K1 to 31K3 are alternately arranged in pairs, constituting the electrolysis-purpose electrode cluster 27 of the electrolyzer 26.

In this case, each pair of electrodes (for example, the anode electrode 31A1 and the cathode electrode 31K1) can work for electrolysis, which can lead to improving the OH-radical generation efficiency.

As described above, according to the first embodiment, the water treatment system 10 can efficiently generate OH radicals to oxidatively decompose persistent substances in the water.

### 2. Second Embodiment

The first embodiment has described the single water treatment unit 14 installed between the upstream existing pipe 12 and the downstream existing pipe 13. The second embodiment is different therefrom in that two water treatment units 14 are connected to each other in series.

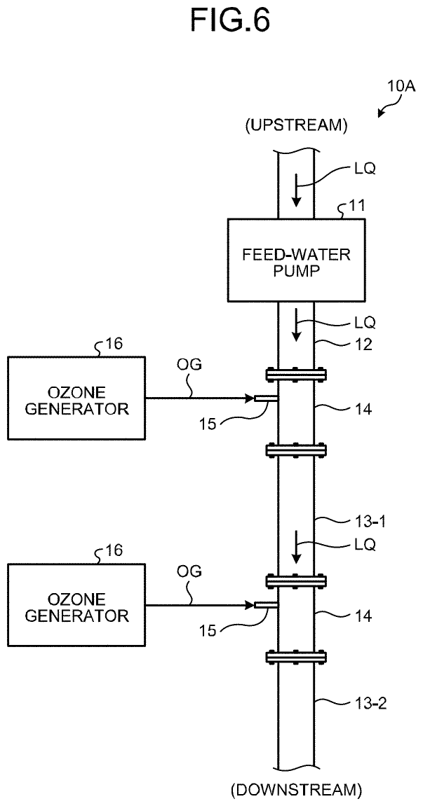

FIG. 6 is a schematic configuration block diagram of a water treatment system of the second embodiment.

FIG. 6 depicts the same elements as those in FIG. 1 of the first embodiment by the same reference numerals. Detailed descriptions of such elements are incorporated herein by reference.

A water treatment system 10A according to the second embodiment includes a first downstream pipe 13-1 and a second downstream pipe 13-2 instead of the downstream existing pipe 13, two water treatment units 14 located between the upstream existing pipe 12 and the first downstream pipe 13-1 and between the first downstream pipe 13-1 and the second downstream pipe 13-2. The water treatment units 14 are connected to each other in series.

In this case, the water treatment units 14 operate in the same manner as in the first embodiment. However, the water LQ supplied to the water treatment unit 14 located more downstream than the other water treatment unit 14 is lower in pressure. It is therefore preferable to adjust the pressure applied by the feed-water pump 11 or the pressure of the ozone-containing gas OG generated by the corresponding ozone generators 16 to set an appropriate pressure level.

According to the second embodiment, the water treatment system 10A can supply larger amounts of hydrogen peroxide and OH radicals to the water LQ to be able to oxidatively decompose a larger amount of persistent substances in the water.

### 3. Third Embodiment

The second embodiment has described the two water treatment units 14 connected in series. A third embodiment is different therefrom in that two water treatment units 14 are connected in parallel.

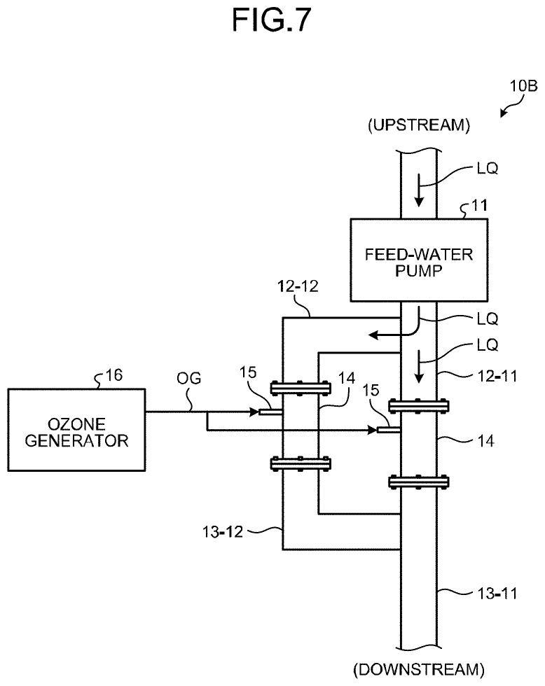

FIG. 7 is a schematic configuration block diagram of a water treatment system according to the third embodiment.

FIG. 7 depicts the same elements as those in FIG. 1 of the first embodiment by the same reference numerals. Detailed descriptions of such elements are incorporated herein by reference.

A water treatment system 10B according to the third embodiment includes a first upstream pipe 12-11 and a second upstream pipe 12-12 branching from the first upstream pipe 12-11 instead of the upstream existing pipe 12.

The water treatment system 10B further includes a first downstream pipe 13-11 and a second downstream pipe 13-12 branching from the first downstream pipe 13-11 instead of the downstream existing pipe 13.

One of the water treatment units 14 is located between the first upstream pipe 12-11 and the first downstream pipe 13-11, and the other water treatment unit 14 is located between the second upstream pipe 12-12 and the second downstream pipe 13-12.

In the third embodiment, substantially the same water pressure is applied to the two water treatment units 14. The feed-water pump 11 is expected to exert a larger water feed capacitance (water supply capacity) than in the second embodiment, which is to be satisfied.

According to the third embodiment, the water treatment system 10B can supply larger amounts of hydrogen peroxide water and OH radicals to the water LQ and can oxidatively decompose a larger amount of persistent substances in the water LQ without increase in pressure of the water LQ.

### 4. Modifications of Embodiments

### 4.1. First Modification

The above embodiments have described a flat-plate electrode as an example of the electrolysis-purpose electrode. The first modification concerns preventing rectification of turbulence to thereby more effectively improve the OH-radical generation efficiency.

The first modification focus on the structure of each electrode, and descriptions of the electrode arrangement in the embodiments are incorporated herein by reference.

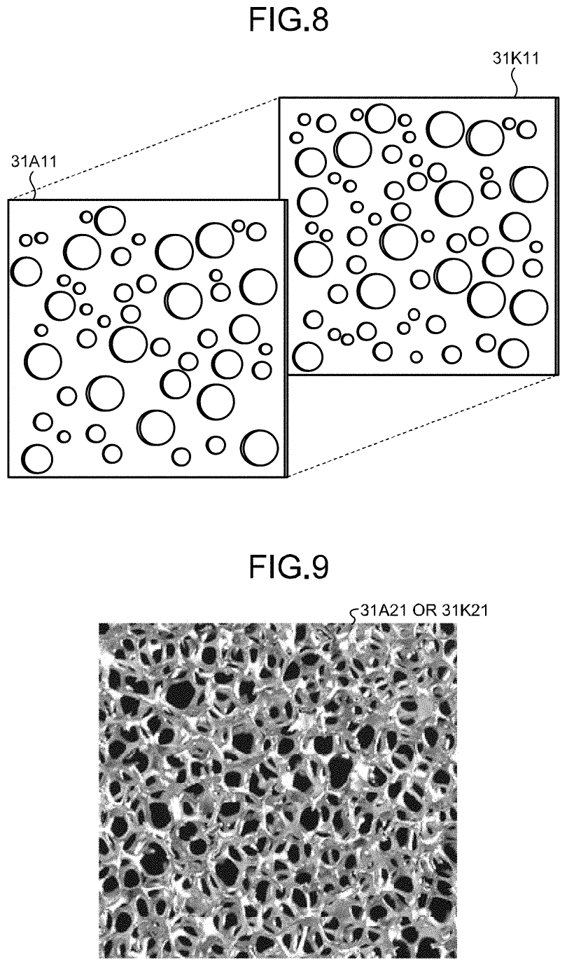

FIG. 8 illustrates electrodes according to the first modification of the embodiments.

The electrodes according to the first modification serve to generate OH radicals having higher oxidizing power and oxidatively decompose persistent substances in the water, without use of hydrogen peroxide as a reagent. The electrodes are an anode electrode 31A11 and a cathode electrode 31K11 of a pair.

As configured above, flowing through in-between the anode electrode 31A11 and the cathode electrode 31K11, the flow of the water LQ turns into random turbulence, which enables improvement in the OH-radical generation efficiency.

Furthermore, the anode electrode 31A11 and the cathode electrode 31K11 in the first modification are porous flat-plate electrodes with randomly arranged holes of different diameters. Applying such anode and cathode electrodes to the pairs of electrodes illustrated in FIG. 5 can enhance the OH-radical generation efficiency in proportion to increase in the number of electrodes insofar as no substantial increase in channel resistance occurs.

4.2 Second Modification

The above embodiments have described the use of the flat plate-like electrodes. A second modification uses electrodes having a three-dimensional shape.

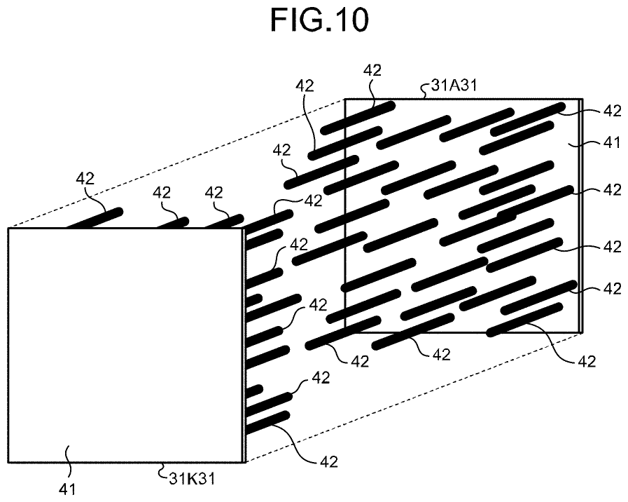

FIG. 9 illustrates an electrode according to the second modification of the embodiments.

In FIG. 9, black portions correspond to holes (openings).

As illustrated in FIG. 9, an anode electrode 31A21 and a cathode electrode 31K21 of the second modification have a three-dimensional porous (spongy) form, and can maintain the turbulence of the water LQ while maintaining their surface areas.

The surface of the cathode electrode 31K21 is preferably hydrophobic so as to facilitate absorption of oxygen gas to be a raw material of hydrogen peroxide. Thus, the cathode electrode 31K21 is made of, for example, a porous carbon electrode core coated with Teflon (registered trademark)-based suspension (to impart hydrophobic property) and electroconductive carbon powder (to impart porousness).

According to the second modification, flowing through in-between the anode electrode 31A21 and the cathode electrode 31K21, the flow of the water LQ turns into random turbulence, which makes it possible to improve the OH-radical generation efficiency.

4.3 Third Modification

FIG. 10 illustrates electrodes according to a third modification of the embodiments.

As illustrated in FIG. 10, an anode electrode 31A31 and a cathode electrode 31K31 according to the third modification are in the form of a pinholder and each include an electrode base 41 of a plate form and a plurality of electrodes 42 of a rod form standing on the electrode base 41.

The rod-like electrodes 42 of the anode electrode 31A31 and the cathode electrode 31K31 are randomly arranged so as not to interfere with each other, when the anode electrode 31A31 and the cathode electrode 31K31 closely oppose each other. Thereby, the anode electrode 31A31 and the cathode electrode 31K31 can serve to maintain the turbulence of the water LQ while maintaining their surface areas.

As with the cathode electrode 31K21 of the third embodiment, the surface of the cathode electrode 31K31 is preferably hydrophobic so as to facilitate absorption of oxygen gas to be a raw material of hydrogen peroxide. Thus, the cathode electrode 31K21 is made of, for example, a porous carbon electrode core coated with Teflon (registered trademark)-based suspension (to impart hydrophobic property) and electroconductive carbon powder (to impart porousness).

According to the third modification, flowing through in-between the anode electrode 31A31 and the cathode electrode 31K31, the flow of the water LQ can turn into random turbulence, which enables improvement in the OH-radical generation efficiency.

4.4 Fourth Modification

The second embodiment and the third embodiment have described the example of using one feed-water pump 11. However, the number of feed-water pumps can be two or more corresponding to the number of water treatment units 14.

5. Effects of Embodiments

The respective embodiments can provide a water treatment system of a simple structure at a lower cost without the use of hydrogen peroxide as a reagent.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A water treatment system comprising:
a water treatment device;
a feed-water pump that feeds water to be treated to the water treatment device;
an ozone generator that generates ozone-containing gas containing ozone gas and oxygen gas; and
a direct-current power supply that supplies direct-current power, wherein the water treatment device comprises:
an ejector including
an inlet-side wider-diameter part into which the water is introduced,
a nozzle in communication with the inlet-side wider-diameter part and having a sidewall provided with an inlet opening into which the ozone-containing gas is introduced, and
an outlet-side wider-diameter part in communication with the nozzle, from which the water mixed with the ozone-containing gas is ejected; and
an electrolyzer located downstream of the ejector and including an electrolysis-purpose electrode supplied with the direct-current power to electrolyze the ejected water mixed with the ozone-containing gas.

2. The water treatment system according to claim 1, comprising
a plurality of water treatment devices, wherein
the water treatment devices are mutually connected in series downstream of the feed-water pump.

3. The water treatment system according to claim 1, comprising
a plurality of water treatment devices, wherein
the water treatment devices are mutually connected in parallel downstream of the feed-water pump.

4. The water treatment system according to claim 1, wherein
the electrolysis-purpose electrode includes an electrode of a flat-plate form with randomly arranged holes of different diameters.

5. The water treatment system according to claim 1, wherein
the electrolysis-purpose electrodes include a three-dimensional electrode formed of a porous material with communication holes.

6. The water treatment system according to claim 1, wherein
the electrolysis-purpose electrode comprises a cathode electrode including:
an electrode core;
a porous carbon layer laminated on the electrode core; and
a hydrophobic layer formed on a surface of the porous carbon layer by coating.

7. The water treatment system according to claim 1, wherein
the electrolysis-purpose electrode comprises pairs of anode electrodes and cathode electrodes.
